(19) United States
(12) Patent Application Publication
(10) Pub. No.: US 2010/0125446 A1
(43) Pub. Date: May 20, 2010

(54) METHOD FOR MODIFYING DOCUMENT IN DATA PROCESSING DEVICE

(76) Inventor: Dana L. Wathen, Long Beach, CA (US)

Correspondence Address: LAW OFFICE OF JERRY D. HAYNES , P.A, P.O. Box 350392, Fort Lauderdale, FL, 33335, US

(21) Appl. No.: 12/274,746

(22) Filed: Nov. 20, 2008

(51) Int. Cl. G06F 17/28; G06F 17/00

(52) U.S. Cl. 704/2; 715/234; 715/273

(57) ABSTRACT

Disclosed is a method for modifying a textual matter of a document in a data processing device. The method comprises receiving a first textual matter contained in the document, converting the first textual matter to a second textual matter based on a user selection, and displaying the second textual matter. The conversion of the first textual matter to the second textual matter comprises at least one of translating a first language associated with the first textual matter to a second language associated with the second textual matter, and converting a first currency denomination associated with the first textual matter to a second currency denomination associated with the second textual matter.

### FIELD OF THE INVENTION

The present invention relates generally to modification of a document in a data processing device, and, more particularly, to a method for modifying a textual matter of a document in a data processing device.

### BACKGROUND OF THE INVENTION

In today's world, globalization of the economy has resulted in increase in interactions between people belonging to different countries. The use of various data processing devices such as computer and internet for such interactions is well known in the art. However, people from different countries may experience a language barrier during such interactions. In particular, people may experience the language barrier in written communication. For example, the language barrier may arise in a situation when a person tries to access a document, such as a word document, a spread sheet or a web page, containing textual matter written in a foreign language.

Additionally, people may experience the language barrier while trading with a foreign company. For example, a person may experience the language barrier while buying and selling a product or a service, provided by or to the foreign company. More specifically, when a cost associated with the product or the service is specified in a foreign currency, the person may find difficulty in evaluating an actual cost associated with the product or the service.

Accordingly, there exists a need for modifying a document for converting a textual matter of the document from one language to another language. Additionally, there exits a need for converting a currency denomination associated with one textual matter to a currency denomination associated with another textual matter.

### SUMMARY OF THE INVENTION

In view of the foregoing disadvantages inherent in the prior art, the general purpose of the present invention is to provide a method for modifying a document in a data processing device configured to include all the advantages of the prior art, and to overcome the drawbacks inherent therein.

Accordingly, an object of the present invention is to provide a method for modifying a document for converting a textual matter of the document from one language to another language.

Another object of the present invention is to provide a method for converting a currency denomination associated with one textual matter to another currency denomination.

In light of the above objects, in one aspect of the present invention, a method for modifying a document in a data processing device is disclosed. The method comprises receiving a first textual matter contained in the document; converting the first textual matter to a second textual matter based on a user selection; and displaying the second textual matter.

In another aspect the present invention, the conversion of the first textual matter to the second textual matter comprises translating a first language associated with the first textual matter to a second language associated with the second textual matter.

In yet another aspect the present invention, the conversion of the first textual matter to the second textual matter comprises converting a first currency denomination associated with the first textual matter to a second currency denomination associated with the second textual matter.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, in which:

FIG. 1 illustrates a flow chart depicting a method for modifying a document in a data processing device, in accordance with an exemplary embodiment of the present invention; and

FIG. 2 illustrates a perspective view of a computer readable medium having instructions for modifying a document in a data processing device, in accordance with an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in implementation thereof. It should be emphasized, however, that the present invention is not limited to a method for modifying a document in a data processing device, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a method for modifying a document in a data processing device. More specifically, in one embodiment, the present invention provides a method for modifying a textual matter of the document in the data processing device. Further, in another embodiment, the present invention provides a method for converting a first currency denomination associated with the first textual matter to a second currency denomination associated with the second textual matter.

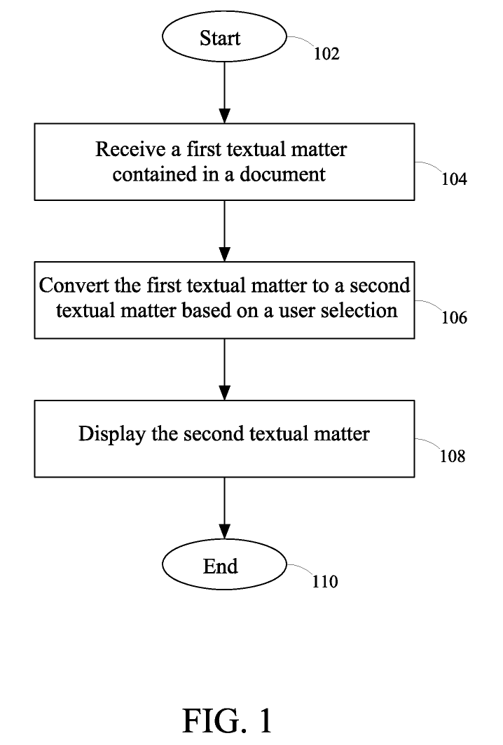

Referring to FIG. 1, a flow chart depicting a method for modifying a document in a data processing device is illustrated, in accordance with an exemplary embodiment of the present invention. The method for modifying the document in the data processing device starts at 102. The term ‘data processing device’ used herein refers to at least one of a computing device and a mobile device. It will be obvious to a person skilled in the art that the data processing device may include a display device, an input device and a central processing unit. Further, the term ‘document’ used herein refers to at least one of a word document, a spreadsheet, and a Hyper Text Markup Language (HTML) page.

The data processing device receives a first textual matter contained in the document at 104. In one embodiment of the present invention, the first textual matter contained in the document may be received by using the input device of the data processing device. Alternatively, the first textual matter may be received from an external device or a network.

In one embodiment of the present invention, the first textual matter may include a text in a first language, such as Japanese language contained in the document, such as a word document. In another embodiment, the first textual matter may include a first currency denomination, such as an amount of currency in Yen, contained in the document such as a spreadsheet. The first textual matter contained in the document may be displayed on the display device of the data processing device. In one embodiment of the present invention, the first textual matter may be scanned in the data processing device.

The received first textual matter contained in the document may be converted to a second textual matter based on a user selection at 106. In one embodiment of the present invention, the user selection refers to an option of conversion of the first textual matter in the first language to a second textual matter in the second language. For example, the user may be provided with an option to convert a text matter in a Chinese language to a text matter in a French language.

In another embodiment of the present invention, the user selection refers to an option of conversion of a first currency denomination associated with the first textual matter to a second currency denomination associated with the second textual matter. For example, the user may be provided with an option to convert an amount of currency in Euros to a corresponding amount of the currency in US dollars.

As explained herein, the first currency denomination may be converted to the second currency denomination based on a defined currency exchange rate. The term ‘defined currency exchange rate’ used herein refers to worth of a first currency compared to a second currency. Accordingly, the defined currency exchange rate defines a rate at which the first country's currency may be exchanged for the second country's currency. In one embodiment of the present invention, the defined currency exchange rate may be acquired from a currency exchange office. More specifically, the present invention acquires the defined currency exchange rate for the first currency denomination and the second currency denomination form the currency exchange office. Accordingly, on user selection for converting the first currency denomination associated with first textual matter to the second currency denomination associated with the second currency denomination, the present invention relates to the currency exchange office for acquiring the defined currency exchange rate and thereby converting the currency denominations.

Upon conversion of the first textual matter to the second textual matter based on the user selection, the second textual matter may be displayed at 108. More specifically, the display device of data processing device may show the second textual matter. In one embodiment of the present invention, the second textual matter is the textual matter associated with the second language. More specifically, the second textual matter may be the translated text in the second language. Accordingly, in the present embodiment, the text matter in the second language may be displayed on the display device of the data processing device. In another embodiment, the second textual matter is the textual matter associated with the second currency denomination. Accordingly, in the present embodiment, the converted currency in the second currency denomination may be displayed on the display device of the data processing device. Thereafter, the method for modifying the document in the data processing device is terminated at 110.

As described above, the embodiments of the present invention may be embodied in the form of computer-implemented processes and apparatuses for modifying a document in a data processing device. Embodiments of the present invention may also be embodied in the form of computer program product containing instructions embodied in tangible media, such as floppy diskettes, CD-ROMs, hard drives, or any other computer-readable medium, wherein, when the computer program product is loaded into and executed by a computer, the computer becomes an apparatus for practicing the present invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present invention. When implemented on a general-purpose microprocessor, the computer program code segments configure the microprocessor to create specific logic circuits. Accordingly, the computer readable medium may have the computer program product implemented thereon, i.e., having instructions for modifying a textual matter of a document in a data processing device.

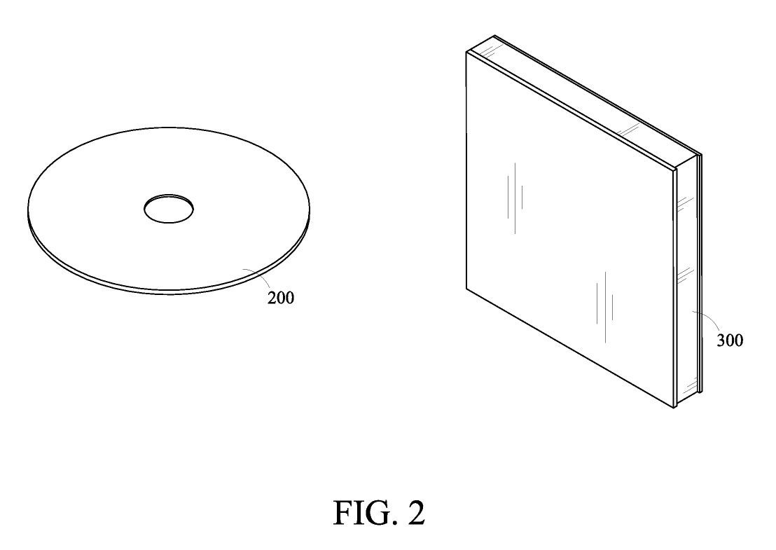

Referring to FIG. 2, a perspective view of a computer readable medium having instructions for modifying the document in the data processing device is illustrated, in accordance with an exemplary embodiment of the present invention. As shown in FIG. 2, in one embodiment of the present invention, the computer readable medium is a Compact Disc-Read Only Memory (CD-ROM) 202, hereinafter referred to as the CD 202. Further, for storing the computer readable medium such as the CD 202 a case 204 is also illustrated in FIG. 2.

The computer program product, implemented on the computer readable medium such as the CD 202, may be loaded into and executed by the data processing device. The computer program product disclosed herein may further include instructions for providing a user with options of dialog boxes, menu templates and guides for enabling the user to make the selection for converting the first textual matter to the second textual matter. More specifically, the user may convert the first textual matter to the second textual matter by clicking at least one of the dialog boxes, the menu templates and the guides provided by the computer program product.

In one embodiment of the present invention, the computer program product may include a plurality of libraries for enabling the conversion of the first textual matter in the first language to the second textual matter in the second language. Each library of the plurality of libraries may relate to information regarding vocabulary and grammar of a particular language, such as English, French, German, and the like. Each library may further include information for establishing links between different libraries that is required for enabling conversion of a word or phrase in the particular language into another language. Also, each library may contain information regarding currency of a particular country and conversion rates thereof with respect to currencies of other countries. Specifically, the present invention enables in correlating two libraries of the plurality of libraries based on the user selection. For example, the first language may be associated with a first language library, such as a Chinese language library, and the second language may be associated with a second language library, such as a French language library. Accordingly, upon selection by the user for converting the first textual matter to the second textual matter, the first language library interacts with the second language library to receive verbatim translation of the first textual matter in the second language. Similarly, for currency conversion, the plurality of libraries may include currency libraries relating to currencies of different countries. Accordingly, in the described embodiment, the first textual matter may be converted to the second textual matter.

Moreover, the computer program product may further provide options for performing a spelling check and a grammar check by clicking at least one of the dialog boxes, the menu templates and the guides.

It will be evident to a person skilled in the art that the computer program product, as described herein, may exhibit polymorphism that enables the computer program product to act as a uniform interface for converting a textual matter from the first language to the second language or conversion of the textual matter from the first currency denomination to the second currency denomination. Specifically, the same computer program product may enable the user for conversion of text between two languages or two currencies.

With reference to FIG. 2, the computer readable medium, such as the CD 202 may be stored in a case such as the case 204. In one embodiment of the present invention, the case, such as the case 204 may include setup instructions for loading or executing the computer readable medium such as CD 202 in the data processing device.

The computer program product disclosed herein may be loaded or executed on a server such that a plurality of data processing devices connected to the server, by a wired or wireless means, may access the computer program product installed and executed on the server. For example, a company may install the computer program product in a company's server such that all employees of the company, located worldwide, may access the computer program product through the company's server. Accordingly, the disclosed computer program product may facilitate international business between different countries. The computer program product of the present invention may be compatible with operating systems known in art, such as Microsoft Windows, Linux, Mac OS X, AmigaOS, and Solaris. Moreover, as explained herein the computer program product of the present invention facilitates conversion of a textual matter of a document from one language to another language, thereby enabling a written interaction between people of different geographical origins without having a language barrier.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A method for modifying a document in a data processing device, the method comprising:
receiving a first textual matter contained in the document;
converting the first textual matter to a second textual matter based on a user selection; and
displaying the second textual matter.

2. The method of claim 1, wherein converting the first textual matter to the second textual matter comprises translating a first language associated with the first textual matter to a second language associated with the second textual matter.

3. The method of claim 1, wherein converting the first textual matter to the second textual matter comprises converting a first currency denomination associated with the first textual matter to a second currency denomination associated with the second textual matter.

4. The method of claim 3, wherein the first currency denomination is converted to the second currency denomination based on a defined currency exchange rate.

5. The method of claim 1, wherein the document is at least one of a spreadsheet, a word document and a Hyper Text Markup Language (HTML) page.

6. A computer program product embodied on a computer readable medium for modifying a document in a data processing device, the computer program product comprising a program module having instructions for:
receiving a first textual matter contained in the document;
converting the first textual matter to a second textual matter based on a user selection; and
displaying the second textual matter.

7. The computer program product according to claim 6, wherein the instructions for converting the first textual matter to the second textual matter comprises instructions for translating a first language associated with the first textual matter to a second language associated with the second textual matter.

8. The computer program product according to claim 6, wherein the instructions for converting the first textual matter to the second textual matter comprises instructions for converting a first currency denomination associated with the first textual matter to a second currency denomination associated with the second textual matter.

9. The computer program product according to claim 8, wherein the first currency denomination is converted to the second currency denomination based on a defined currency exchange rate.

10. The computer program product according to claim 6, wherein the document is at least one of a spreadsheet, a word file and a Hyper Text Markup Language (HTML) page.
